(19) United States
(12) Patent Application Publication
(10) Pub. No.: US 2025/0245442 A1
(43) Pub. Date: Jul. 31, 2025

(54) GENERATING CAUSAL QUERY OUTCOMES USING DEEP CAUSAL MACHINE-LEARNING MODEL MODELS

(71) Applicant: Microsoft Technology Licensing, LLC, Redmond, WA (US)

(72) Inventors: Swati SHARMA, Hayward, CA (US); Ranveer CHANDRA, Kirkland, WA (US); Emre Mehmet KICIMAN, Seattle, WA (US); Maria Angels DE LUIS BALAGUER, Redmond, WA (US); Shachi Shailesh DESHPANDE, New York, NY (US)

(21) Appl. No.: 18/422,876

(22) Filed: Jan. 25, 2024

(51) Int. Cl. G06F 40/40; G06Q 50/02; G06V 20/13

(52) U.S. Cl. CPC G06F 40/40; G06Q 50/02; G06V 20/13

(57) ABSTRACT

This disclosure describes a causal query system that determines causal outcomes for agriculture-based causal queries using one or more deep causal machine-learning models, including deep multimodal causal machine-learning models. For example, the causal query system generates one or more deep causal machine-learning models to determine targeted causal outcomes based on combinations of treatments and covariates. Additionally, in many instances, these deep causal machine-learning models also allow for various types of data input, such as overhead images and unstructured data.

### BACKGROUND

The landscape of computational devices has witnessed significant advancements in both hardware and software domains, particularly in the deployment of deep-learning models. An example is the agricultural field, where practitioners are increasingly leveraging machine learning and generative artificial intelligence (AI) to derive valuable insights into farming operations. However, current systems struggle with several technical challenges. These challenges include processing multimodal information, which is often hampered by sparse data, noise, and the task of correlating features. Additionally, integrating these models with contemporary large language models presents another challenge. Moreover, conventional systems struggle to determine causal estimates due to the presence of unobserved confounders and insufficient data. These are just a few of the many technical obstacles facing existing systems.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of the causal query system using a deep causal machine-learning model and a large generative model to generate a response to a causal query.

FIG. 2 illustrates an example computing environment where the causal query system is implemented.

FIGS. 3A-3B illustrate example diagrams for using a deep causal machine-learning model and a deep multimodal causal machine-learning model to generate causal outcomes.

FIGS. 4A-4B illustrate example diagrams for generating a deep causal machine-learning model.

FIGS. 5A-5B illustrate example diagrams for generating a response to the causal query based on a deep causal machine-learning model and a large generative model.

FIG. 6 illustrates an example graphical user interface for providing a response to a causal query.

FIG. 7 illustrates an example series of acts in a computer-implemented method for generating a causal query output using a deep causal machine-learning model.

FIG. 8 illustrates example components included within a computer system used to implement the causal query system.

### DETAILED DESCRIPTION

This disclosure describes a causal query system that determines causal outcomes for agriculture-based causal queries using one or more deep causal machine-learning models, including deep multimodal causal machine-learning models. For example, the causal query system generates one or more deep causal machine-learning models to determine targeted causal outcomes based on combinations of treatments and covariates. Additionally, in many instances, these deep causal machine-learning models allow for various types of data input, such as overhead images and unstructured data.

Implementations of the present disclosure provide benefits and solve problems in the art with systems, computer-readable media, and computer-implemented methods by using a causal query system to determine agriculture-based causal outcomes accurately and flexibly using deep causal machine-learning models. As described below, the causal query system utilizes deep causal machine-learning models, and in some cases, a large generative model (LGM), to efficiently determine causal outcomes for causal queries. Additionally, the causal query system flexibly allows for multimodal inputs including images and unstructured data to generate accurate and unbiased causal outcomes.

To elaborate, in various implementations, the causal query system receives an agriculture-based causal query for a causal outcome based on a treatment variable and a covariate variable. In response, the causal query system utilizes a large generative model to determine a selection of a deep causal machine-learning model that is generated based on the treatment variable, the covariate variable, and the causal outcome. In determining the causal query, the causal query system obtains an overhead agricultural image and generates an embedding for the covariate variable from the image. In addition, the causal query system uses the selected deep causal machine-learning model to generate a causal outcome based on the treatment variable and the embedding. Furthermore, the causal query system provides a response that includes the causal outcome to answer the agriculture-based causal query.

In some implementations, the causal query system generates an embedding for a covariate variable from an overhead agricultural image provided as input to a deep causal machine-learning model. The deep causal machine-learning model is generated based on variable types associated with a treatment variable, the covariate variable, and a causal outcome. In addition, the causal query system generates the causal outcome using the deep causal machine-learning model based on the treatment variable and the embedding. Furthermore, in these implementations, the causal query system provides a response based on the causal outcome in response to an agriculture-based causal query for the causal outcome based on the treatment variable and the covariate variable.

As described in this disclosure, the causal query system delivers several significant technical benefits in terms of improved flexibility and accuracy compared to existing systems. Moreover, the causal query system provides several practical applications that address problems related to providing accurate and unbiased causal outcomes that are also customized for targeted domains.

To illustrate, the causal query system improves flexibility by allowing for multimodal data inputs including images and unstructured data. Existing systems require structured data arranged in a particular manner to be usable to determine causal outcomes. This structured data precludes images and unstructured data. In contrast, the causal query system flexibly allows for image data. In some implementations, the causal query system also allows for unstructured data to be input into a deep multimodal causal machine-learning model.

As mentioned, the causal query system determines accurate and unbiased causal outcomes. To elaborate, existing systems use processes such as propensity score models and generative AI models to determine causal outcomes. However, propensity score models do not work well with multimodal inputs and are prone to failures when scaled. Generative AI models do not produce accurate answers when processing unstructured data and are limited in performing counterfactual estimations. Most existing systems for causal effect estimation do not work well on high-dimensional data and are not developed to incorporate multiple modalities. In contrast, the causal query system generates accurate causal effects (e.g., outcomes), and counterfactual estimations, and works with unstructured covariates.

These improvements in efficiency and accuracy are further manifested in data domains that include complex, diverse, and precise data. To illustrate, the agriculture domain requires knowledge about crops, soils, weather patterns, remote sensing farm data (e.g., soil moisture, crop health, temperature, and other environmental factors that affect agricultural output), ecological interactions, water management, and time-series historical data corresponding to farming activities like fertilizer usage, irrigation, and yields. Furthermore, data from one agricultural operation can vary significantly from operations across a region, at an adjacent operation, or even within the same operation, making it challenging to determine accurate causal outcomes. Nonetheless, the causal query system allows for accurate and efficient determinations of causal outcomes for operations in the agriculture domain.

In some implementations, the causal query system improves efficiency compared to conventional systems. For example, in many implementations, the causal query uses an LGM at various stages to interact with different components. By using the LGM, the causal query system more efficiently determines which components to interact with and how to effectively communicate with a given component to achieve the desired outcome. The causal query system also uses the LGM to identify the appropriate deep causal machine-learning models to call to determine a particular causal outcome and to generate refined answers of the causal outcomes. By using the framework and leveraging the LGM to efficiently target components, the causal query system achieves causal outcomes in fewer operations than conventional systems require.

As illustrated in the foregoing discussion, this disclosure utilizes a variety of terms to describe the features and advantages of one or more implementations described. To illustrate, this disclosure describes the causal query system in the context of a cloud computing system.

As an example, the term “causal query” refers to a question or inquiry made within the context of a targeted domain (e.g., agriculture), where the question is aimed at understanding the cause-and-effect relationships between variables. A causal query typically involves identifying the impact of a change in one variable (the cause) on another variable (the effect). For instance, a causal query might be: “If I have 35 points of nitrogen in the soil, how much fertilizer should I apply to my spring wheat crop?” Often, a causal query includes a treatment (e.g., fertilizer), a covariate (e.g., nitrogen, wheat), and a desired causal outcome (e.g., yield).

As another example, this document uses the terms “treatment variable,” “covariate variable,” and “causal effect.” In various examples, the term “treatment” refers to an action, intervention, or change that is applied to an entity. The term “covariate” refers to a variable that can influence the result of an experiment or study but is not the main focus of the study. For example, a covariate variable is like a background factor that is not the main focus of an outcome but can still affect what is being studied. The term “causal effect” refers to the results or effects that are measured after the treatment is applied that happened because of the treatment. Sometimes, a causal effect is measured as an average treatment effect (ATE).

Also, the term “machine-learning model” refers to a computer model or computer representation that can be trained (e.g., optimized) based on inputs to approximate unknown functions. For instance, a machine-learning model can include, but is not limited to, an autoencoder model, a distortion classification model, a neural network (e.g., a convolutional neural network or deep learning model), a decision tree (e.g., a gradient-boosted decision tree), a linear regression model, a logistic regression model, or a combination of these models (e.g., an image restoration machine-learning model that includes an autoencoder model (autoencoder for short) and a distortion classification model (distortion classification for short)).

The term “deep causal machine-learning model” refers to a deep-learning machine-learning model that is generated to create one or more causal outcomes based on one or more treatments and one or more covariates. Often, a deep causal machine-learning model utilizes a trained encoder and decoder to determine causal outcomes based on one or more covariates determined or derived from one or more overhead mages. In additional implementations, the deep multimodal causal machine-learning model accepts additional input types (different types) including unstructured data. As mentioned above, a treatment refers to an intervention or action applied to the input data, while a covariate is a characteristic or feature of the input data that can influence the outcome.

The ability of the deep causal machine-learning model to determine causal outcomes often relies on covariates extracted from various data sources, such as overhead images, unstructured data, and/or structured data. In various implementations, the deep multimodal causal machine-learning model is multimodal and accepts additional input types (different types), including unstructured data. In various implementations, the deep causal machine-learning model is a deep causal neural network or a deep multimodal causal neural network.

As another example, the term “neural network” refers to a machine learning model comprising interconnected artificial neurons that communicate and learn to approximate complex functions, generating outputs based on multiple inputs provided to the model. For instance, a neural network includes an algorithm (or set of algorithms) that employs deep learning techniques and utilizes training data to adjust the parameters of the network and model high-level abstractions in data. Various types of neural networks exist, such as convolutional neural networks (CNNs), residual learning neural networks, recurrent neural networks (RNNs), generative neural networks, generative adversarial neural networks (GANs), and single-shot detection (SSD) networks.

As an example, a “large generative model” (LGM) is a large artificial intelligence system that uses deep learning and a large number of parameters (e.g., in the billions or trillions), which are trained on one or more vast datasets, to produce fluent, coherent, and topic-specific outputs (e.g., text and/or images). In many instances, a generative model refers to an advanced computational system that uses natural language processing, machine learning, and/or image processing to generate coherent and contextually relevant human-like responses.

Additionally, large generative models have applications in natural language understanding, content generation, text summarization, dialogue systems, language translation, creative writing assistance, image generation, audio generation, and more. A single large generative model often performs a wide range of tasks based on receiving different inputs, such as prompts (e.g., input instructions, rules, example inputs, example outputs, and/or tasks), data, and/or access to data. In response, the large generative model generates various output formats ranging from one-word answers to long narratives, images and videos, labeled datasets, documents, tables, and presentations.

Moreover, large generative models (LGMs) are primarily based on transformer architectures to understand, generate, and manipulate human language. LGMs can also use a recurrent neural network (RNN) architecture, a long short-term memory (LSTM) model architecture, a convolutional neural network (CNN) architecture, or another architecture type. Examples of LGMs include generative pre-trained transformer (GPT) models including GPT-3.5 and GPT-4, bidirectional encoder representations from transformers (BERT) models, text-to-text transfer transformer models such as T5, conditional transformer language (CTRL) models, and Turing-NLG. Other types of large generative models include sequence-to-sequence models (Seq2Seq), vanilla RNNs, and LSTM networks. In various implementations, an LGM is a multimodal generative model that receives multiple input formats (e.g., text, images, video, data structures) and/or generates multiple output formats.

The term “prompt” refers to an input or question provided by the user to the large generative model (LGM). A prompt serves as the primary source of information for the LGM to understand a request or query. For example, a prompt can be a specific question, a request for information, or a command for action. The LGM processes these prompts and generates responses based on the information provided in the prompt, the context of the conversation, and the guidelines or parameters set by any accompanying system-level prompts. For instance, a user prompt could be a request for a definition, or a query about a specific domain (e.g., agriculture). A prompt may be generated based on a user prompt. Examples of prompts include a causal graph creation prompt, a causal query prompt, a causal script prompt, and a plain language prompt, each of which is further described below.

Additionally, as an example, a “network” refers to one or more data links that enable electronic data transport between computer systems and/or modules and/or other electronic devices. A network may include public networks such as the Internet as well as private networks. When information is transferred or provided over a network or another communications connection (either hardwired, wireless, or a combination of hardwired or wireless) to a computer, the computer properly views the connection as a transmission medium. Transmission media can include a network and/or data links that can be used to carry the needed program code means in the form of computer-executable instructions or data structures and which can be accessed by a general-purpose or special-purpose computer. Combinations of the above are also included within the scope of computer-readable media.

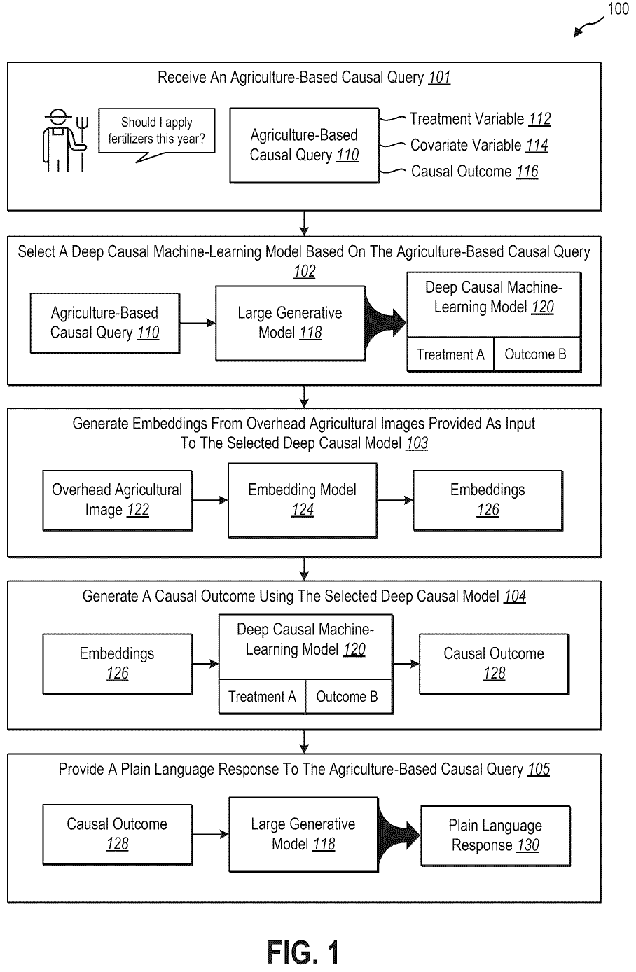

Implementation examples and details of the causal query system are discussed in connection with the accompanying figures, which are described next. For example, FIG. 1 illustrates an example overview of the causal query system using a deep causal machine-learning model and a large generative model to generate a response to a causal query according to some implementations. As shown, FIG. 1 includes a series of acts 100 performed by or with the causal query system.

As shown in FIG. 1, the series of acts 100 includes act 101 of receiving an agriculture-based causal query. For example, the causal query system receives a causal query from a farmer or another user that corresponds to agricultural operations (e.g., an agriculture-based causal query 110). In various implementations, the causal query includes a request for a causal outcome 116 based on a treatment variable 112 and a covariate variable 114. In some implementations, the causal query is based on multiple treatments and/or covariate variables.

In this document, causal queries represent counterfactual queries asking “what if” questions that help farmers understand the potential outcomes of different scenarios. Examples of agriculture-based causal queries include “What if there is a drought or heavy rain during the growing season?” or “Which crop should I plant this year?”

Act 102 includes selecting a deep causal machine-learning model based on the agriculture-based causal query. In various implementations, the causal query system generates a set of deep causal machine-learning models including various deep causal multimodal models. For example, the causal query system generates different deep causal models corresponding to different combinations of treatments, covariates, and/or causal outcomes. In these implementations, the causal query system utilizes a large generative model 118 to determine a deep causal machine-learning model 120 based on the agriculture-based causal query 110. For instance, the large generative model 118 determines the optimal deep causal machine-learning model to utilize based on the treatment variable 112 and the covariate variable 114 in the agriculture-based causal query 110.

In addition, the causal query system generates embeddings from overhead agricultural images provided as input to the selected deep causal machine-learning model, as shown in act 103. For example, in various implementations, the causal query system obtains an overhead agricultural image 122 that corresponds to the agricultural operation associated with the causal query. Then, using an embedding model 124 within or associated with the selected deep causal machine-learning model to generate embeddings 126 from the overhead agricultural image 122 based on the covariate variable 114

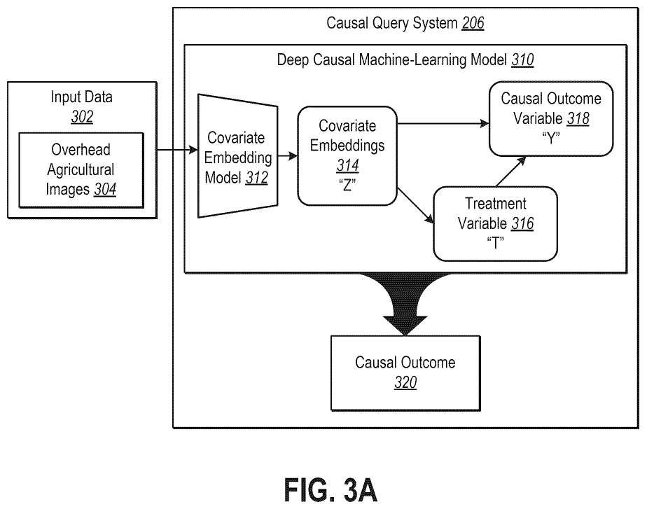

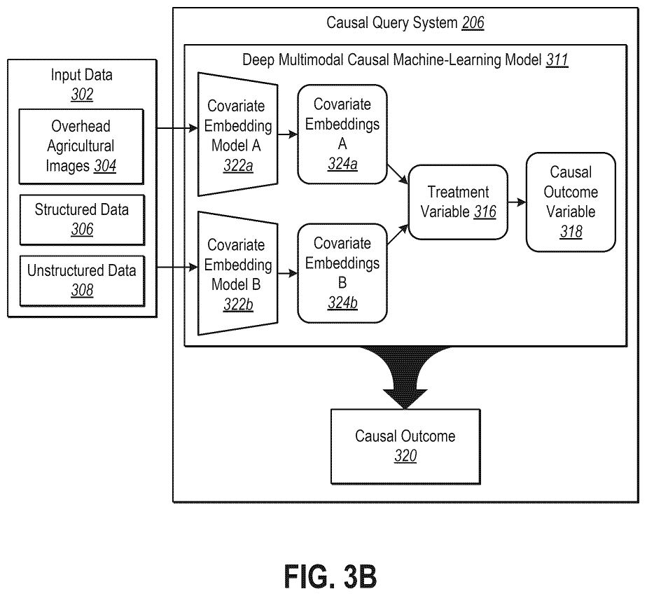

In some implementations, where multiple covariate variables are needed, the causal query system generates multiple sets of embeddings. Furthermore, in some implementations, the causal query system generates multiple sets of embeddings for the same covariate variable from different data inputs. Additional details about generating embeddings are provided below in connection with FIGS. 3A-3B.

Act 104 includes generating a causal outcome using the selected deep causal machine-learning model. For example, the causal query system uses the embeddings 126 and the deep causal machine-learning model 120 to generate a causal outcome 128. In particular, the selected deep causal model uses its training to determine the causal outcome 128 based on the embeddings of the covariate variable and the treatment. Additional details about generating causal outcomes are provided below in connection with FIGS. 3A-3B.

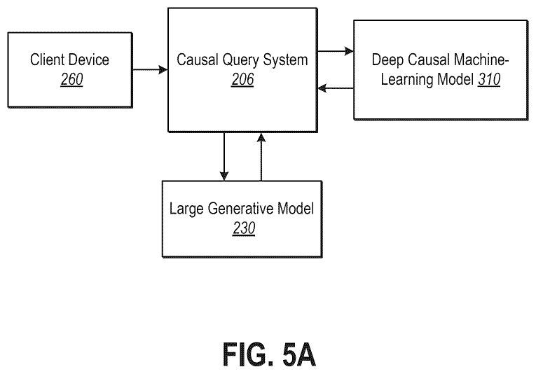

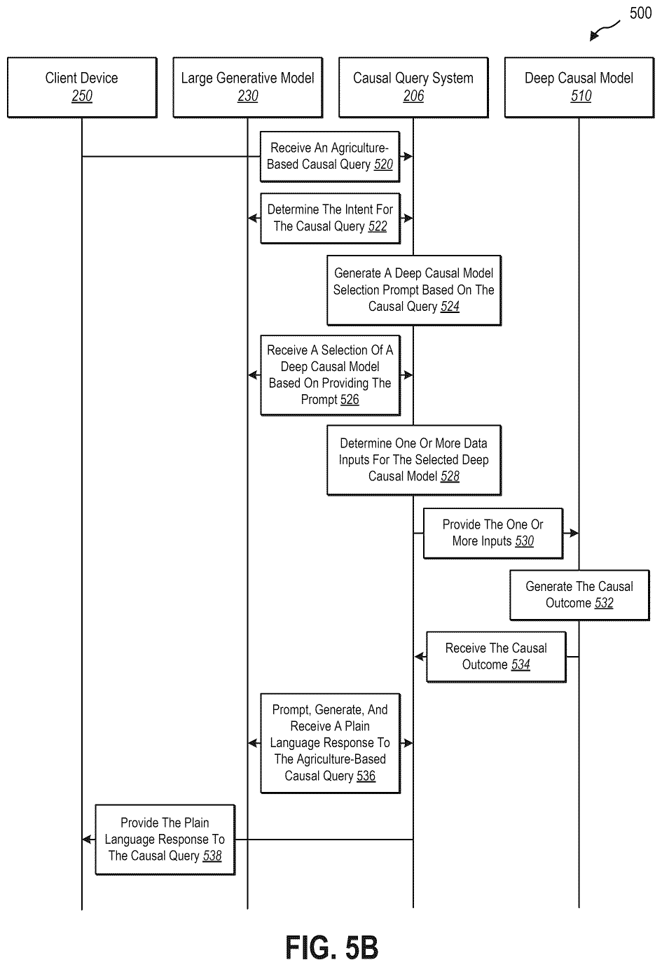

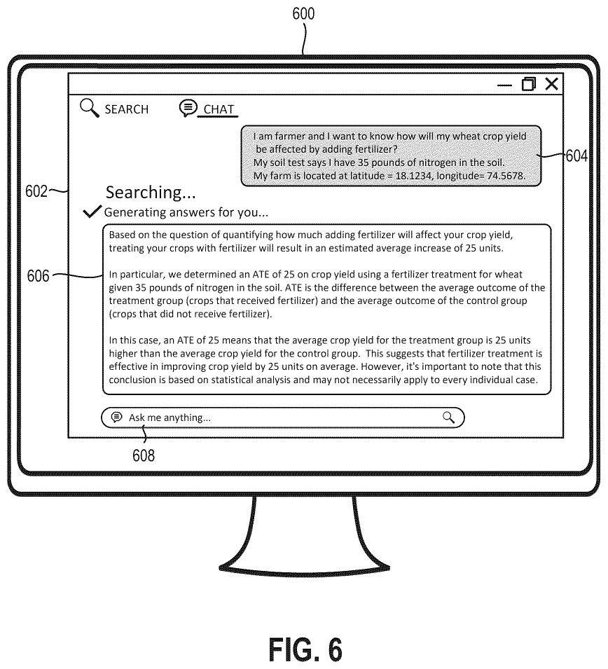

Additionally, act 105 includes providing a plain language response to the agriculture-based causal query. For example, the causal query system generates and provides a plain language prompt to the large generative model 118 with instructions to change the causal outcome 128 into a plain language response 130. The causal query system then returns the plain language response 130 to the client device that provided the agriculture-based causal query 110. Additional details about generating a plain language response 130 are provided below in connection with FIGS. 5A-5B, as well as illustrated in FIG. 6.

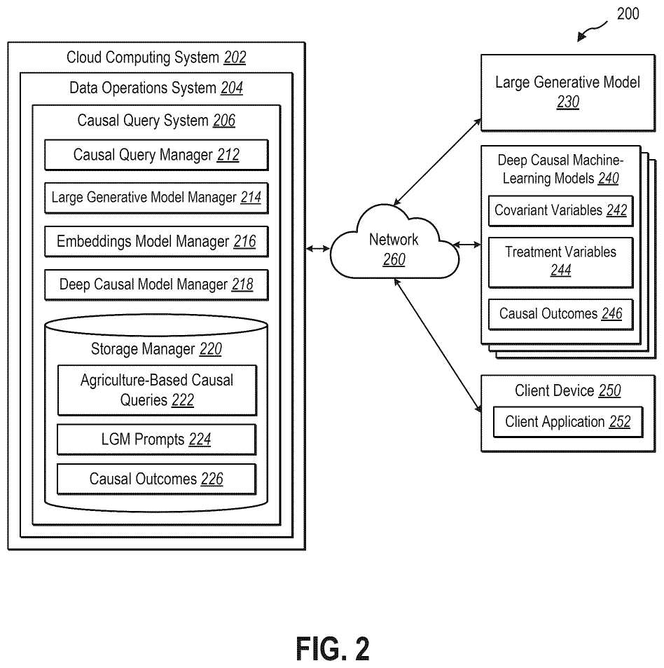

With a general overview in place, additional details are provided regarding the components, features, and elements of the causal query system. To illustrate, FIG. 2 shows an example computing environment where the causal query system is implemented according to some implementations. In particular, FIG. 2 illustrates an example of a computing environment 200 with various computing devices associated with a causal query system 206. While FIG. 2 shows example arrangements and configurations of the computing environment 200, the causal query system 206, and associated components, other arrangements and configurations are possible.

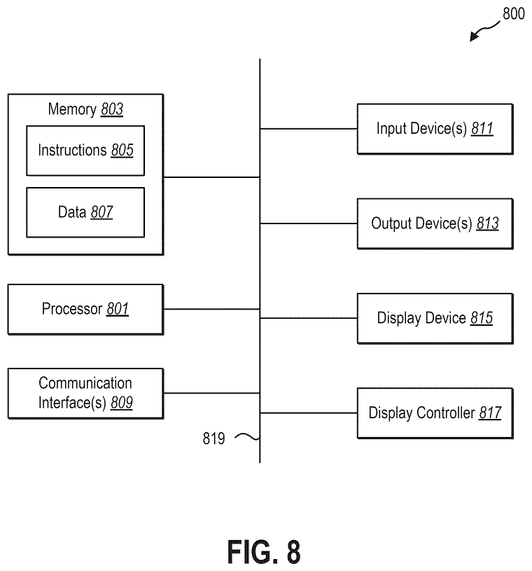

As shown, the computing environment 200 includes a cloud computing system 202 associated with the causal query system 206, a large generative model 230, deep causal machine-learning models 240, and a client device 250, each connected via a network 260. Each of these components may be implemented on one or more computing devices, such as a set of one or more server devices. Further details regarding computing devices are provided below in connection with FIG. 8, along with additional details regarding networks, such as the network 260 shown.

As shown, the cloud computing system 202 includes a data operations system 204, which implements the causal query system 206. In various implementations, the data operations system 204 facilitates operations and functions for data across various domains. For example, the data operations system 204 facilitates data measurements, automation, and data storage. In various implementations, the data operations system 204 provides a user interface to interact with the causal query system 206 and request causal queries.

In FIG. 2, the data operations system 204 includes the causal query system 206. In some implementations, the causal query system 206 is located on a separate computing device from the data operations system 204 within the cloud computing system 202 (or apart from the cloud computing system 202). In various implementations, the data operations system 204 operates without the causal query system 206.

As mentioned earlier, the causal query system 206 generates causal query outcomes for causal queries using deep causal machine-learning models and, in some cases, large generative models. As shown, the causal query system 206 includes various components and elements that are implemented in hardware and/or software. For example, the causal query system 206 includes a causal query manager 212, a large generative model manager 214, an embeddings model manager 216, a deep causal model manager 218, and a storage manager 220. The storage manager 220 includes agriculture-based causal queries 222, LGM prompts 224, and causal outcomes 226.

As mentioned above, the causal query system 206 includes the causal query manager 212, which receives and responds to causal queries (e.g., agriculture-based causal queries 222), such as those from the client device 250. For example, when receiving an agriculture-based causal query, the causal query manager 212 activates a framework within the causal query system 206 needed to determine an accurate and unbiased answer to the query.

The causal query system 206 includes the large generative model manager 214, which interacts with the large generative model 230 to assist the causal query system 206. In some instances, the causal query manager 212 provides one or more of the LGM prompts 224 (e.g., a deep causal model selection prompt and a refined answer prompt) to the large generative model 230 as part of the framework.

The causal query system 206 also includes the embeddings model manager 216, which determines which embeddings model to employ based on the input data type. For example, the embeddings model manager 216 utilizes the same or different embedding models for different data types for inputs to a deep causal machine-learning model. In some implementations, the embeddings model manager 216 facilitates training one or more embedding models.

The causal query system 206 includes the deep causal model manager 218, which works with the deep causal machine-learning models 240 to determine causal outcomes 226. In some implementations, the deep causal model manager 218 assists in generating, training, fine-tuning, and/or obtaining one or more of the deep causal machine-learning models 240. The deep causal model manager 218 also implements selected instances of the deep causal machine-learning models 240 to determine causal outcomes 226 that correspond to agriculture-based causal queries 222.

The computing environment 200 includes the large generative model 230. The large generative model 230 communicates with the causal query system 206 to generate various outputs according to the prompts and framework of the causal query system 206. In some implementations, the large generative model 230 is located within the cloud computing system 202. In some implementations, the large generative model 230 represents multiple instances of the same or different large generative models. In some implementations, the large generative model 230 is a large language model (LLM).

The deep causal machine-learning models 240 include one or more deep causal machine-learning models. The deep causal machine-learning models (or deep causal models for short) may include different models associated with different combinations of covariate variables 242, treatment variables 244, and causal outcomes 246. In some implementations, a deep causal model may be trained to process multiple treatment variables, covariate variables, and/or causal outcomes, where the specific variables and outcomes are chosen via a hyperparameter.

As shown, the computing environment 200 includes the client device 250. In various implementations, the client device 250 is associated with a user (e.g., a user client device), such as a user who requests a causal query (e.g., an agriculture-based causal query). In various instances, the client device 250 includes a client application 252, such as a web browser, mobile application, or another form of computer application for accessing and/or interacting with the cloud computing system 202 and/or the causal query system 206. For example, the client device 250 provides a causal query, and in response, the causal query system 206 generates and provides a query answer in a plain language response by following the framework described in this document.

Turning to the next figures, FIGS. 3A-3B illustrate example diagrams for using a deep causal machine-learning model and a deep multimodal causal machine-learning model to generate causal outcomes according to some implementations. In particular, FIG. 3A illustrates a deep single-modal causal model, while FIG. 3B illustrates a deep multimodal causal model.

As shown, FIG. 3A includes the causal query system 206 with various components. FIG. 3A also shows input data 302 with overhead agricultural images 304. The causal query system 206 includes a deep causal machine-learning model 310 with a covariate embedding model 312, and variables that include covariate embeddings 314 (e.g., “Z”), a treatment variable 316 (e.g., “T”), and a causal outcome variable 318 (e.g., “Y”). The causal query system 206 also shows the causal outcome 320 that is generated by the deep causal machine-learning model 310.

In some implementations, the covariate embedding model 312 is located separately from the deep causal machine-learning model 310. For instance, the causal query system 206 utilizes a separate instance of the covariate embedding model 312 and provides the covariate embeddings 314 to the deep causal machine-learning model 310 as an input.

In various implementations, the causal query system 206 selects the deep causal machine-learning model 310 based on the causal outcome 320 associated with the causal query. In additional implementations, the causal query system 206 selects the deep causal machine-learning model 310 based on the covariate embeddings 314 and the treatment variable 316.

In various implementations, the causal query system 206 utilizes a large generative model to select the deep causal machine-learning model 310 from a set of differently trained deep causal models based on the same or different factors. For example, the causal query does not include a covariate and/or a treatment variable. In some instances, the causal query provides requests for a causal outcome 320 that would be better answered with a covariate and/or a treatment variable not included in the query, and the large generative model determines that a given deep causal model can determine the desired causal outcome.

As shown, the input data 302 includes the overhead agricultural images 304. In some instances, these overhead agricultural images 304 include images captured from satellites, drones, piloted vehicles (e.g., planes, helicopters, gliders), balloons, or taken from a high vantage point. In one or more implementations, the overhead agricultural images 304 include a set of time-series snapshots of the same location (e.g., a farm or agriculture operation). In various implementations, overhead agricultural images include images that include remote sensing data (e.g., captured energy emissions and/or other data “sensed” from overhead). In some instances, the overhead agricultural images 304 include multiple sets of overhead images for different locations. In various implementations, the input data 302 includes different types of data, such as structured data, unstructured data, temporal data, or synthesized data.

In various implementations, the causal query system 206 obtains the overhead agricultural images 304 from an image repository. For example, the causal query system 206 provides a target location (e.g., GPS coordinates) to an image repository and retrieves one or more time-series images of the target location across time. In some implementations, the overhead agricultural images 304 and/or other instances of the input data 302 are provided by the user in connection with the causal query. For example, the causal query system 206 receives data from the user when they make the causal query.

Returning to FIG. 3A, the causal query system 206 receives the overhead agricultural images 304 as input data 302 and provides it to the covariate embedding model 312. In the illustrated implementation, the covariate embedding model 312 is suited for overhead agricultural images 304 based on the covariate. In particular, the covariate embedding model 312 generates embeddings that encode the covariate from the overhead agricultural images 304 into feature vectors. For example, if the covariate is a crop type, a precipitation type, or a particular nutrient, the covariate embedding model 312 will convert indications of the covariate from an overhead image into a feature vector embedding.

As shown, the deep causal machine-learning model 310 determines the treatment variable 316 from the covariate embeddings 314 and the treatment variable 316. The deep causal machine-learning model 310 determines the causal outcomes by comparing the effect of a particular treatment with the observed outcomes of what would have happened in the absence of the treatment. In various implementations, the deep causal machine-learning model 310 performs causal analysis and/or causal inference on the input data 302 even if the input data includes images or unstructured data. In contrast, conventional causal models often require input data to be structured in a particular way before they can perform a causal analysis.

Upon processing the covariate embeddings 314 and the causal outcome variable 318, the deep causal machine-learning model 310 generates the causal outcome variable 318. In various implementations, the causal outcome variable 318 is an average treatment estimation (ATE). The causal query system 206 then provides the causal outcome variable 318 as the causal outcome 320.

FIG. 3B expands upon the implementations of FIG. 3A. In particular, FIG. 3B illustrates using a deep multimodal causal machine-learning model to generate causal outcomes according to some implementations. The deep multimodal causal machine-learning model 311 enables the causal query system 206 to process multiple types of data and determine causal relationships between different variables across the different data types.

Along these lines, the input data 302 in FIG. 3B includes multiple different input types including the overhead agricultural images 304, structured data 306, and unstructured data 308. The input data 302 may also include additional data types, such as structured data, unstructured data, temporal data, and/or synthesized data, as discussed above.

FIG. 3B includes a deep multimodal causal machine-learning model 311. The deep multimodal causal machine-learning model 311 includes multiple covariate embedding models, such as a first covariate embedding model 322a (“Embedding Model A”) and a second covariate embedding model 322b (“Embedding Model B”), along with the variables (e.g., the treatment variable 316 and the causal outcome variable 318). While two covariate embedding models are shown, a deep multimodal causal machine-learning model 311 can include any number of embedding models for different input data types and/or covariates.

To elaborate, the first covariate embedding model 322a generates first covariate embeddings 324a (“Covariate Embeddings A”) corresponding to a first input type. As shown, the first covariate embedding model 322a generates the first covariate embeddings 324a for the overhead agricultural images 304. The second covariate embedding model 322b generates second covariate embeddings 324b (“Covariate Embeddings B”) corresponding to a second input type.

As shown, the second covariate embedding model 322b generates the second covariate embeddings 324b for the unstructured data 308. In various implementations, the first covariate embedding model 322a and the second covariate embedding model 322b and/or the first covariate embeddings 324a and the second covariate embeddings 324b correspond to the same covariate for the different input data types. In some instances, the first covariate embedding model 322a and the second covariate embedding model 322b correspond to different covariates.

After generating the multiple sets of covariate embeddings, the causal query system 206 uses the deep multimodal causal machine-learning model 311 to determine the causal outcome variable 318 based on the treatment variable 316. In some implementations, the causal query system 206 follows the inference objective of computing the estimation E [Y=y|do(T=t)] via Monte-Carlo estimation. The causal query system 206 may also use stochastic gradient descent (SGD) to train the deep multimodal causal model to approximate the relationships between the variables Z, T, and Y. Indeed, as discussed below, the deep multimodal causal machine-learning model 311 is trained to generate the causal outcome variable 318 based on the set of covariate embeddings generated from the different input data types and the treatment variable 316. Once the causal outcome variable 318 is determined, the deep multimodal causal machine-learning model 311 provides it as the causal outcome 320.

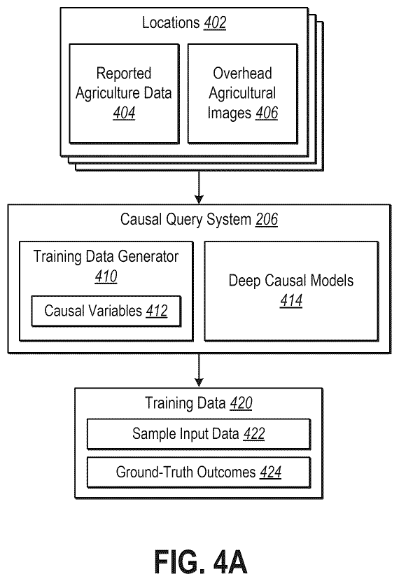

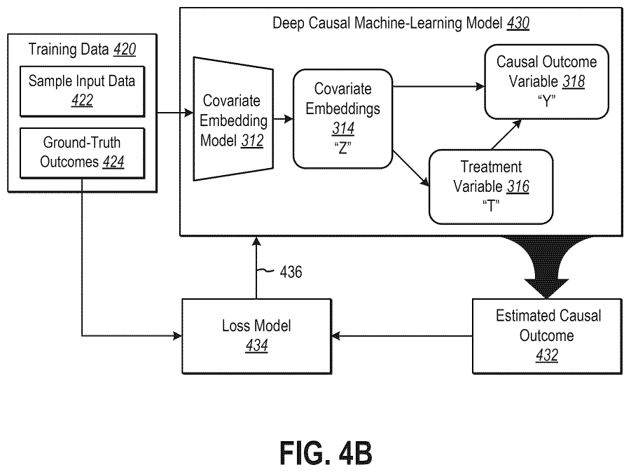

FIGS. 4A-4B illustrate example diagrams for generating a deep causal machine-learning model according to some implementations. In particular, FIG. 4A includes generating training data and FIG. 4B includes the training of a deep causal machine-learning model.

As shown, FIG. 4A includes the causal query system 206, locations 402, and training data 420. As shown, the locations 402 include reported agriculture data 404 and overhead agricultural images 406 for each location. The causal query system 206 includes a training data generator 410 based on causal variables 412 (e.g., covariate embeddings, treatment variables, and causal outcome variables) and deep causal models 414. The training data 420 includes sample input data 422 and ground truth outcomes 424.

In some implementations, the reported agriculture data 404 is a dataset that includes several outcomes including the yield of one or more crop plants. It may also include data on possible treatments such as fertilizer application, fertilizer type, field irrigation data, irrigation times, etc.; historical weather data for different farm environments; comprehensive environmental covariates as computed using one or more simulations for crop growth; and/or genomic sequence data for plants. The overhead agricultural images 406 may include time-series satellite snapshots for farms at different locations, from which farming information can be derived, such as crop quality, soil, water cover, etc.

In various implementations, data from the locations 402 is provided to the causal query system 206. In some implementations, the causal query system 206 receives agriculture data 404 for a target location and obtains corresponding overhead agricultural images for the target location from an image repository. For example, the causal query system 206 correlates or aligns the agriculture data 404 to a set of overhead agricultural images 406 that share the same location. Furthermore, the causal query system 206 correlates the agriculture data 404 and the overhead agricultural images 406 based on timestamps (e.g., for the same time period or window).

With agriculture data 404 and overhead agricultural images 406 from a target location, the training data generator 410 can generate training data 420 for a deep causal model based on a set of causal variables. For example, the training data generator 410 identifies a combination of one covariate embedding, treatment variable, and causal outcome variable and identifies the corresponding values from the agriculture data 404. In particular, the training data generator 410 identifies ground truth outcomes 424 for a given treatment variable and covariate. The training data generator 410 then generates the sample input data 422 from a corresponding overhead image.

In various implementations, the training data generator 410 generates different sets of training data for different combinations of causal variables 412. In some implementations, the training data generator 410 generates sets of training data for a deep causal model that utilizes multiple treatment variables, covariates, and/or causal outcomes. After generating or otherwise obtaining the training data 420 for a deep causal model, the causal query system 206 trains the deep causal model, as described next in connection with FIG. 4B.

As mentioned, FIG. 4B corresponds to training a deep causal machine-learning model according to some implementations. FIG. 4B includes the training data 420, a deep causal machine-learning model 430, and a loss model 434. The training data 420 includes the sample input data 422 and ground truth outcomes 424 for a given deep causal model, and the deep causal machine-learning model 430 includes a covariate embedding model 312 and causal variables (e.g., covariate embeddings 314, treatment variable 316, and causal outcome variable 318).

In various implementations, the deep causal machine-learning model 430 is a convolutional neural network or another type of deep-learning neural network. In one or more implementations, the causal query system 206 uses supervisory learning to train the deep causal machine-learning model 430 based on the sample input data 422 and the ground truth outcomes 424 in the training data 420.

As one example, in various implementations, the causal query system 206 provides the sample input data 422 to the deep causal machine-learning model 430, which generates the covariate embeddings 314 using the covariate embedding model 312. The deep causal machine-learning model 430 then generates the causal outcome variable 318 based on the treatment variable 316 and the covariate embeddings 314 and outputs an estimated causal outcome 432 (e.g., an ATE value).

In this example, the causal query system 206 utilizes a loss model 434 to compare a ground-truth outcome to the estimated causal outcome 432 for the sample input data 422 to determine an amount of error or loss. The causal query system 206 provides the error amount as feedback 436 to the deep causal machine-learning model 430 to refine and fine-tune the model. Indeed, in various implementations, the loss model 434 may use one or more loss functions. The loss amount is provided back to the deep causal machine-learning model 430 as feedback 436 to tune the weights, parameters, layers, and/or nodes of the model. The causal query system 206 may train the deep causal machine-learning model 430 via backpropagation in an end-to-end manner until the model converges or satisfies another training criterion.

In some implementations, the causal query system 206 trains the covariate embedding model 312 jointly with the other layers of the deep causal machine-learning model 430. For example, the causal query system 206 jointly trains the components of the model for a predetermined number of iterations or epochs. In some implementations, the covariate embedding model 312 is trained to determine covariate embeddings 314 separately from the neural network layers of the deep causal machine-learning model 430. In some implementations, the covariate embedding model 312 is pre-trained (e.g., an encoder that has been trained to extract features from satellite images of farms).

While training a deep single-modal causal model is described, similar approaches can be used to train a deep multimodal causal model. For example, the causal query system 206 can train multiple covariate embedding models to generate different sets of covariate embeddings along with other machine-learning layers in a deep multimodal causal model.

FIGS. 5A-5B illustrate example diagrams for generating a response to the causal query based on a deep causal machine-learning model and a large generative model according to some implementations. In particular, FIG. 5A illustrates a block diagram showing the components with which the causal query system 206 communicates to generate agriculture-based causal outcomes. FIG. 5B illustrates a sequence diagram for generating the same.

As shown, FIG. 5A includes components such as the causal query system 206, the network 260, the deep causal machine-learning model 310, and a deep causal model 510. The deep causal model 510 may represent either a deep causal machine-learning model or a deep multimodal causal machine-learning model, as described above. The causal query system 206 uses these components to generate a causal outcome and convert it into a plain language response back to the requesting user.

FIG. 5B provides a more in-depth description of an example process. In particular, FIG. 5B illustrates a sequence diagram of communications and actions between the causal query system 206, the large generative model 230, the deep causal model 510, and the client device 250. FIG. 5B also includes a series of acts 500 performed by or with the causal query system 206.

The series of acts 500 includes act 520 of the causal query system 206 receiving an agriculture-based causal query from a client device. For example, a user on the client device 250 requests a causal query about an agricultural operation. In response, the client device 250 provides the causal query directly or indirectly to the causal query system 206. For instance, the causal query system 206 provides a client application that enables a user to interact with the causal query system 206 to request a causal query.

As a non-limiting example, suppose the user is a farmer who wants to know how changing an operation will affect farming outcomes (e.g., a causal query). For instance, the farmer may be interested in the effects of adding more fertilizer, planting more seeds, using a new tractor, or changes in weather patterns (e.g., a cause) on crop yields (e.g., an effect) based on one or more attributes (e.g., covariates) of the crop. Based on a cause, the farmer desires to know the effect it will have in one or more categories.

Act 522 shows the causal query system 206 and the large generative model 230 interacting to determine the intent of the causal query. For example, the causal query system 206 generates and provides an intent determination prompt (e.g., an LGM prompt) to the large generative model 230 to obtain one or more intents from the agriculture-based causal query. The large generative model 230 may return one or more intents, related causal queries, and/or suggestions for obtaining additional information from the client device 250.

Along these lines, the causal query system 206 may seek additional information from the client device 250. For example, the causal query system 206 may request location information (e.g., latitude, longitude) of the farm in question. In a factory example, the causal query system 206 may request information about the products being made or the available budgets. In general, the causal query system 206 may request information related to covariates and/or treatments of the causal query.

Act 524 includes the causal query system 206 generating a deep causal model selection prompt based on the causal query. For example, the causal query system 206 generates one or more LGM prompts that instruct the large generative model 230 to determine a specific deep causal model that corresponds to the treatment and causal outcome indicated by the causal query. In some implementations, the large generative model 230 also considers one or more covariate variables when selecting the deep causal model.

Act 526 shows the causal query system 206 receiving a selection of a deep causal model based on the prompt provided. For example, the causal query system 206 provides the deep causal model selection prompt to the large generative model 230, which determines the deep causal model 510 and returns the selection to the causal query system 206 in response. In various implementations, the large generative model 230 provides multiple deep causal models that the causal query system 206 may use to determine an answer to the causal query (e.g., the different deep causal models are based on different types and/or combinations of input data).

Act 528 shows the causal query system 206 determining one or more data inputs for the selected deep model. Upon the deep causal model 510 being selected, the causal query system 206 determines which inputs are needed by the model. For example, the selected model requires satellite images as input. In another example, the model is multimodal and accepts multiple input types. In some instances, a model allows for multiple input types but can operate with a minimum number of inputs (e.g., a model accepts image data, structured data, and unstructured data and can determine a causal outcome with at least one data input type).

As part of act 528, the causal query system 206 can obtain the necessary data. For example, the causal query system 206 makes a call to an external source (e.g., an image repository) to obtain one or more satellite images of the agricultural operation corresponding to the causal query. As mentioned earlier, the causal query system 206 may prompt the client device 250 for additional information needed to provide an accurate and unbiased answer to the causal query.

Act 530 includes the causal query system 206 providing the one or more inputs to the deep causal model 510. Because the deep causal model 510 is trained on a particular set or combination of covariate, treatment, and outcome variables, the deep causal model 510 is configured to determine a causal outcome based on the input according to different treatment values.

To illustrate, act 532 shows the deep causal model 510 generating the causal outcome from the inputs. In various implementations, the input is an overhead agricultural image (e.g., a satellite, drone, or aerial image) where the indicated covariate is converted into embeddings using an embeddings model. The covariate embeddings are then encoded along with the treatment variable and decoded within the deep causal model 510 to generate the causal outcome (e.g., an ATE value), as described above. Act 534 includes the causal query system 206 receiving the causal outcome from the deep causal model 510.

In various implementations, the causal outcome is a raw value without additional context. For example, the causal outcome is “ATE=25” or “25.” Accordingly, act 536 includes the causal query system 206 prompting, generating, and receiving a plain language response to the agriculture-based causal query. For example, the causal query system 206 generates a plain language answer prompt to provide to the large generative model 230 to cause the model to generate a text narrative response in plain language for the causal outcome using the raw causal outcome. In some implementations, the causal query system 206 provides the plain language prompt to the large generative model 230 along with the agriculture-based causal query. In various instances, the plain language prompt also includes instructions to provide additional context information regarding the raw answer so that a layperson understands the causal answer and why it has the determined effect.

Act 536 also includes the causal query system 206 receiving a plain language response as a refined answer from the large generative model 230. For example, the causal query system 206 receives text, images, and/or links from the large generative model 230 as part of the refined answer to the agriculture-based causal query. In addition, the causal query system 206 provides the plain language response to the client device 250 in response to receiving the causal query, as shown in act 538.

FIG. 6 illustrates an example graphical user interface for providing a response to an agriculture-based causal query according to some implementations. As illustrated, FIG. 6 includes a computing device 600 with a display showing a graphical user interface 602. The computing device 600 may be a desktop, laptop, mobile device, or another type of client device.

As shown, the graphical user interface 602 is displayed as part of a client application that allows access to functions of the causal query system 206, such as via a data operations system. For example, the client application is a web browser client application that enables a user to submit causal queries to the causal query system 206. In some implementations, the client application is a standalone application (e.g., a mobile app) or is otherwise integrated into a data operations system.

The graphical user interface 602 shows a general search display where a user can provide input for various queries included in the causal query. As shown, the graphical user interface 602 includes an input field 608 for providing a causal query. The graphical user interface 602 may include additional elements for uploading or otherwise providing datasets to the causal query system 206.

The graphical user interface 602 also includes a session record of previously asked and answered queries. To illustrate, the session record shows an agriculture-based causal query and response. In particular, the causal query 604 includes a causal question about crop yield (e.g., the causal outcome) given a wheat crop, a location, and nitrogen soil levels (e.g., the covariates) and based on fertilizer applications (e.g., the treatment). The causal query system 206 then provides the plain language response 606 to the computing device 600.

The graphical user interface 602 allows the user to ask follow-up and/or additional questions to the causal query system 206, including further agriculture-based causal queries using the input field 608. For example, a user can ask another agriculture-based causal query that may require the causal query system 206 to use the same or different deep causal machine-learning models to determine a causal outcome.

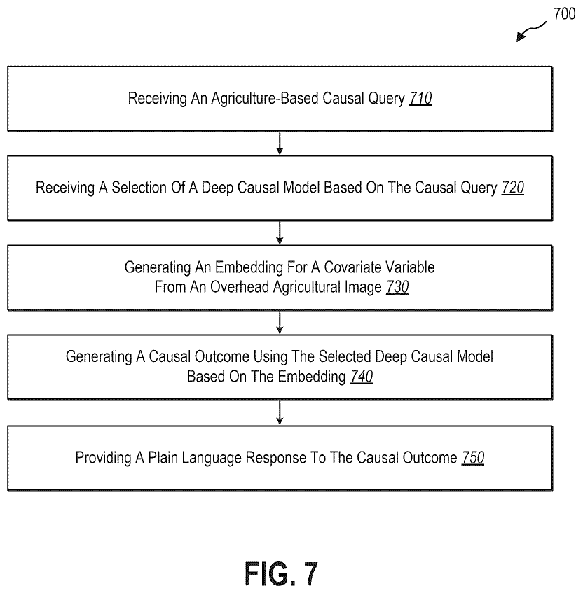

Turning now to FIG. 7, this figure illustrates an example series of acts in a computer-implemented method for generating a causal query output using a deep causal machine-learning model according to some implementations. While FIG. 7 illustrates acts according to one or more implementations, alternative implementations may omit, add, reorder, and/or modify any of the acts shown. In particular, FIG. 7 includes a series of acts 700 for generating an agriculture-based causal outcome using one or more deep causal machine-learning models.

The acts in FIG. 7 can be performed as part of a method (e.g., a computer-implemented method). Alternatively, a computer-readable medium can include instructions that, when executed by a processing system having a processor, cause a computing device to perform the acts in FIG. 7. In some implementations, a system (e.g., a processing system comprising a processor) can perform the acts in FIG. 7. For example, the system includes a processing system and a computer memory including instructions that, when executed by the processing system, cause the system to perform various actions or steps.

As shown, the series of acts 700 includes act 710 of receiving an agriculture-based causal query. For instance, in example implementations, act 710 involves receiving an agriculture-based causal query for a causal outcome based on a treatment variable and a covariate variable. In various implementations, the agriculture-based causal query is received for a client device associated with a user.

As further shown, the series of acts 700 includes act 720 of receiving a selection of a deep causal model based on the causal query. For instance, in example implementations, act 720 involves receiving, from a large generative model, a selection of a deep causal machine-learning model that is generated based on variable types associated with the treatment variable, the covariate variable, and the causal outcome. In some implementations, act 720 also includes providing the agriculture-based causal query to the large generative model with a prompt to select the deep causal machine-learning model from a set of deep causal machine-learning models generated based on different treatment variables and outcome variables. In some implementations, act 720 also includes determining the overhead agricultural image as a model input based on the deep causal machine-learning model selected by the large generative model.

In some implementations, act 720 also includes determining that the deep causal machine-learning model selected by the large generative model is a multimodal deep causal machine-learning model. In some implementations, act 720 also includes providing unstructured agriculture data, along with the overhead agricultural image, to the multimodal deep causal machine-learning model. In some implementations, act 720 also includes determining the overhead agricultural image as a model input based on the selection of the deep causal machine-learning model, determining an additional input type based on the selection, and providing additional data of the additional input type to the deep causal machine-learning model.

As further shown, the series of acts 700 includes act 730 of generating an embedding for a covariate variable from an overhead agricultural image. For instance, in some implementations, act 730 involves generating an embedding for the covariate variable from an overhead agricultural image that is provided as input to the deep causal machine-learning model. In some implementations, act 730 includes generating an embedding for a covariate variable from an overhead agricultural image that is provided as input to a deep causal machine-learning model where the deep causal machine-learning model is generated based on variable types associated with a treatment variable, the covariate variable, and a causal outcome.

In some implementations, act 730 also includes generating an additional embedding for the covariate variable from the additional data, wherein the additional embedding differs from the embedding. In some implementations, the embedding is generated by a first embedding model that is trained to generate embeddings for a first input type and/or the additional embedding is generated by a second embedding model that is trained to generate embeddings for a second input type. In some implementations, the overhead agricultural image is a satellite image or includes remote sensing data.

Furthermore, the series of acts 700 includes act 740 of generating a causal outcome using the selected deep causal model based on the embedding. For instance, in example implementations, act 740 involves generating the causal outcome using the deep causal machine-learning model based on the treatment variable and the embedding. In some implementations, act 740 includes generating the causal outcome using the deep causal machine-learning model based on the treatment variable and the embedding. In some implementations, the deep causal machine-learning model selected by the large generative model is trained or generated to determine the causal outcome based on multiple treatment variables, multiple covariate variables, and/or generating multiple causal outcomes.

In some implementations, act 740 also includes the deep causal machine-learning model selected by the large generative model being based on multiple covariate variables, treatment variables, or causal outcomes and/or the multiple covariate variables, treatment variables, or causal outcomes used by the deep causal machine-learning model are based on one or more hyperparameters provided to the deep causal machine-learning model.

In some implementations, act 740 also includes training the deep causal machine-learning model by obtaining a set of agriculture data that includes values of multiple agriculture variables for one or more agriculture locations, obtaining a set of overhead agricultural images corresponding to the one or more agriculture locations, generating training data by aligning the set of overhead agricultural images to the values of the multiple agriculture variables for the one or more agriculture locations based on timestamps, and/or training the deep causal machine-learning model based on the covariate variable, the treatment variable, and the causal outcome based on or using the training data. In some implementations, act 740 also includes training an embedding model that generates the embedding for the covariate variable from the overhead agricultural image jointly with training the deep causal machine-learning model.

As further shown, the series of acts 700 includes act 750 of providing a plain language response to the causal outcome. For instance, in example implementations, act 750 involves providing a response based on the causal outcome in response to the agriculture-based causal query. In some implementations, act 740 includes providing a response based on the causal outcome in response to an agriculture-based causal query for the causal outcome based on the treatment variable and the covariate variable. In some implementations, act 750 also includes generating a plain language answer prompt for the large generative model to generate a plain language response based on the causal outcome and the agriculture-based causal query, and providing the plain language response in response to the agriculture-based causal query.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Furthermore, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for generating an agriculture-based causal outcome using one or more deep causal machine-learning models, comprising:
receiving an agriculture-based causal query for a causal outcome based on a treatment variable and a covariate variable;
receiving, from a large generative model, a selection of a deep causal machine-learning model that is generated based on variable types associated with the treatment variable, the covariate variable, and the causal outcome;
generating an embedding for the covariate variable from an overhead agricultural image provided as input to the deep causal machine-learning model;
generating the causal outcome using the deep causal machine-learning model based on the treatment variable and the embedding; and
providing a response based on the causal outcome in response to the agriculture-based causal query.

2. The computer-implemented method of claim 1, further comprising providing the agriculture-based causal query to the large generative model with a prompt to select the deep causal machine-learning model from a set of deep causal machine-learning models generated based on different treatment variables and outcome variables.

3. The computer-implemented method of claim 1, further comprising determining the overhead agricultural image as a model input based on the deep causal machine-learning model selected by the large generative model.

4. The computer-implemented method of claim 1, further comprising determining the deep causal machine-learning model selected by the large generative model is a multimodal deep causal machine-learning model.

5. The computer-implemented method of claim 4, further comprising providing unstructured agriculture data with the overhead agricultural image to the multimodal deep causal machine-learning model.

6. The computer-implemented method of claim 4, further comprising providing structured agriculture data with the overhead agricultural image to the multimodal deep causal machine-learning model.

7. The computer-implemented method of claim 4, further comprising:
determining the overhead agricultural image as a model input based on the selection of the deep causal machine-learning model;
determining an additional input type based on the selection; and
providing additional data of the additional input type to the deep causal machine-learning model.

8. The computer-implemented method of claim 7, further comprising generating an additional embedding for the covariate variable from the additional data, wherein the additional embedding differs from the embedding.

9. The computer-implemented method of claim 8, wherein:
the embedding is generated by a first embedding model trained to generate embeddings for a first input type; and
the additional embedding is generated by a second embedding model trained to generate embeddings for a second input type.

10. The computer-implemented method of claim 1, wherein the deep causal machine-learning model selected by the large generative model is trained to determine the causal outcome based on multiple treatment variables or multiple covariate variables.

11. The computer-implemented method of claim 1, wherein the deep causal machine-learning model selected by the large generative model generates multiple causal outcomes.

12. The computer-implemented method of claim 1, wherein:
the deep causal machine-learning model selected by the large generative model is based on multiple covariate variables, treatment variables, or causal outcomes; and
the multiple covariate variables, treatment variables, or causal outcomes used by the deep causal machine-learning model are based on one or more hyperparameters provided to the deep causal machine-learning model.

13. The computer-implemented method of claim 1, further comprising:
generating a plain language answer prompt for the large generative model to generate a plain language response based on the causal outcome and the agriculture-based causal query, and
providing the plain language response in response to the agriculture-based causal query.

14. The computer-implemented method of claim 1, wherein the overhead agricultural image is a satellite image or includes remote sensing data.

15. A computer-implemented method for generating an agriculture-based causal outcome using one or more deep causal machine-learning models, comprising:
generating an embedding for a covariate variable from an overhead agricultural image provided as input to a deep causal machine-learning model, the deep causal machine-learning model generated is based on variable types associated with a treatment variable, the covariate variable, and a causal outcome; and;
generating the causal outcome using the deep causal machine-learning model based on the treatment variable and the embedding; and
providing a response based on the causal outcome in response to an agriculture-based causal query for the causal outcome based on the treatment variable and the covariate variable.

16. The computer-implemented method of claim 15, further comprising training the deep causal machine-learning model by:
obtaining a set of agriculture data that includes values of multiple agriculture variables for one or more agriculture locations;
obtaining a set of overhead agricultural images corresponding to the one or more agriculture locations;
generating training data by aligning the set of overhead agricultural images to the values of the multiple agriculture variables for the one or more agriculture locations based on timestamps; and
training the deep causal machine-learning model based on the covariate variable, the treatment variable, and the causal outcome based on the training data.

17. The computer-implemented method of claim 15, further comprising training an embedding model that generates the embedding for the covariate variable from the overhead agricultural image jointly with training the deep causal machine-learning model.

18. The computer-implemented method of claim 15, further comprising providing the agriculture-based causal query to a large generative model with a prompt to select the deep causal machine-learning model from a set of deep causal machine-learning models.

19. The computer-implemented method of claim 18, further comprising determining the deep causal machine-learning model selected by the large generative model is a multimodal deep causal machine-learning model.

20. A system for generating an agriculture-based causal outcome using one or more deep causal machine-learning models, comprising:
a processing system; and
a computer memory comprising instructions that, when executed by the processing system, cause the system to perform operations of:
receiving an agriculture-based causal query for a causal outcome based on a treatment variable and a covariate variable;
receiving, from a large generative model, a selection of a deep causal machine-learning model that is generated based on variable types associated with the treatment variable, the covariate variable, and the causal outcome;
generating an embedding for the covariate variable from an overhead agricultural image provided as input to the deep causal machine-learning model;
generating the causal outcome using the deep causal machine-learning model based on the treatment variable and the embedding; and
providing a response based on the causal outcome in response to the agriculture-based causal query.
